(19) United States
(12) Patent Application Publication
(10) Pub. No.: US 2010/0091218 A1
(43) Pub. Date: Apr. 15, 2010

(54) COLOR DISPLAY

(75) Inventors: Soon-Joon RHO, Suwon-si (KR); Hee-Keun LEE, Suwon-si (KR); Baek-Kyun JEON, Yongin-si (KR); Nak-Cho CHOI, Seoul (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/415,279

(22) Filed: Mar. 31, 2009

(30) Foreign Application Priority Data
Oct. 15, 2008 (KR) 10-2008-0101268

(51) Int. Cl. G02F 1/13357

(52) U.S. Cl. 349/68

(57) ABSTRACT

An exemplary embodiment of a display device according to the present invention includes; a cholesteric liquid crystal display including a plurality of cholesteric liquid crystal regions, wherein each of the plurality of cholesteric liquid crystal regions respectively reflect light of predetermined colors, and the plurality of cholesteric liquid crystal regions are classified into two or more different types according to the predetermined color of the reflected light, and an assistance display device including a plurality of emitting regions, wherein each of the plurality of emitting regions is disposed in alignment with one of the plurality of cholesteric liquid crystal regions, and each of the plurality of emitting regions respectively emits light of substantially the same color as the predetermined color of the light reflected by the cholesteric liquid crystal region with which it is aligned.

This application claims priority to Korean Patent Application No. 10-2008-0101268, filed on Oct. 15, 2008, and all the benefits accruing therefrom under 35 U.S.C. §119, the contents of which in its entirety are herein incorporated by reference.

### BACKGROUND

(a) Field

The present disclosure relates to a color display device. More particularly, the present disclosure relates to a color display using a cholesteric liquid crystal.

(b) Description of the Related Art

Currently, various types of flat panel displays are being developed. Among them, a liquid crystal display (“LCD”) is a widely used type of flat panel display.

The LCDs may be classified into a transmissive type and a reflective type, and the reflective LCD displays an image using externally provided ambient light such that a backlight, which may draw a substantial portion of power, is not used. Accordingly, the reflective liquid crystal display is highly applicable for a portable device.

However, the reflective liquid crystal display may have a low reflective efficiency such that the luminance from the display is decreased and the color purity is deteriorated.

### BRIEF SUMMARY

An exemplary embodiment of the present invention improves color purity and luminance of a reflective display device.

Aspects of the present disclosure are not limited to the above-mentioned aspect, and undescribed aspects will be appreciated by those skilled in the art from the following detailed description.

An exemplary embodiment of a display device according to the present invention includes; a cholesteric liquid crystal display including a plurality of cholesteric liquid crystal regions, wherein each of the plurality of cholesteric liquid crystal regions respectively reflect light of predetermined colors, and the plurality of cholesteric liquid crystal regions are classified into two or more different types according to the predetermined color of the reflected light, and an assistance display device including a plurality of emitting regions, wherein each of the plurality of emitting regions is disposed in alignment with one of the plurality of cholesteric liquid crystal regions, and each of the plurality of emitting regions respectively emits light of substantially the same color as the predetermined color of the light reflected by the cholesteric liquid crystal region with which it is aligned.

In one exemplary embodiment, the cholesteric liquid crystal display may include; a first substrate, a first pixel electrode disposed on the first substrate, a first switching element disposed on the first substrate and which switches a voltage applied to the first pixel electrode, a second substrate facing the first substrate, a first common electrode disposed on the second substrate, a first region division member which divides a space between the first substrate and the second substrate into the plurality of cholesteric liquid crystal regions, and a cholesteric liquid crystal material filled in the plurality of cholesteric liquid crystal regions.

In one exemplary embodiment, the plurality of cholesteric liquid crystal regions may be classified into a red reflection region, a green reflection region, and a blue reflection region according to the color of light reflected thereby, and the red reflection region, the green reflection region, and the blue reflection region may be determined by an amount of chiral dopant disposed in the cholesteric liquid crystal material.

In one exemplary embodiment, when an average refractive index of the cholesteric liquid crystal material is n, the helical pitches of the cholesteric liquid crystal in the red reflection region, the green reflection region, and the blue reflection region are respectively Pr, Pg, and Pb, and the central wavelengths of the light reflected in the red reflection region, the light reflected in the green reflection region, and the light reflected in the blue reflection region are respectively λr, λg, and λb, and the following equalities: λr=nPr, λg=nPg, and λb=nPb may be satisfied.

In one exemplary embodiment, the assistance display device may include; a third substrate, a second pixel electrode disposed on the third substrate, a second switching element disposed on the third substrate and which switches a voltage applied to the second pixel electrode, a fourth substrate facing the second substrate, a second common electrode disposed on the fourth substrate, a second region division member which divides the space between the third substrate and the fourth substrate into the plurality of emitting regions, and an electrophoretic material filled in the plurality of emitting regions and including electrophoretic particles having an emitting portion and a dispersion media.

In one exemplary embodiment, the plurality of emitting regions may be classified into a red emitting region, a green emitting region, and a blue emitting region according to a color of the light which is emitted thereby, and the red emitting region, the green emitting region, and the blue emitting region may be determined by an emitting material disposed in the emitting portion of the electrophoretic particles.

In one exemplary embodiment, the electrophoretic particles may further include a light absorption portion disposed on a side substantially opposite to a side on which the emitting portion is disposed.

In one exemplary embodiment, the emitting portion of the electrophoretic particles may include phosphor.

In one exemplary embodiment, the emitting portion of the electrophoretic particles may include quantum dots.

In one exemplary embodiment, the second substrate may be the same substrate as the fourth substrate, and a first common electrode and a second common electrode may be respectively disposed on opposite surfaces of the same substrate.

In one exemplary embodiment, the electrophoretic material may include electrophoretic particles having a light absorption portion and wherein the electrophoretic particles having the light absorption portion are separated from the electrophoretic particles having the emitting portion.

In one exemplary embodiment, when the cholesteric liquid crystal disposed in the cholesteric liquid crystal region is in a focal conic state, the light absorption portion of the electrophoretic particles may be oriented toward the cholesteric liquid crystal display.

In one exemplary embodiment, when the cholesteric liquid crystal of the cholesteric liquid crystal region is in a planar state, the emitting portion of the electrophoretic particles may be oriented toward the cholesteric liquid crystal display.

In one exemplary embodiment, when the cholesteric liquid crystal of the cholesteric liquid crystal region is in a focal conic state, the electrophoretic particles having the light absorption portion may be disposed closer to the cholesteric liquid crystal display than the electrophoretic particles having the emitting portion.

In one exemplary embodiment, when the cholesteric liquid crystal of the cholesteric liquid crystal region is in a planar state, the electrophoretic particles having the emitting portion may be disposed closer to the cholesteric liquid crystal display than the electrophoretic particles having the light absorption portion.

According to an exemplary embodiment of the present invention, the selective reflection of light by the cholesteric liquid crystal layer and the light emitted from the emitting body contribute to the display, thereby realizing a high luminance and high color purity display device.

### BRIEF DESCRIPTION OF THE DRAWINGS

FIG. 1 is a cross-sectional view of an exemplary embodiment of a display device, according to the present invention.

FIG. 2 is a schematic cross-sectional view illustrating a planar structure of a cholesteric liquid crystal.

FIG. 3 is a schematic cross-sectional view of a focal conic structure of a cholesteric liquid crystal.

FIG. 4 is a schematic cross-sectional view of a homeotropic structure of a cholesteric liquid crystal.

FIG. 5 is a graph of a wavelength distribution of an exemplary embodiment of an excitation source.

FIG. 6 is a wavelength distribution graph of red light obtained by applying the excitation source of FIG. 5 to the red region of an electrophoretic display of FIG. 1.

FIG. 7 is a cross-sectional view of another exemplary embodiment of a display device, according to the present invention.

### DETAILED DESCRIPTION OF THE EMBODIMENTS

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the present invention will be described in detail with reference to the accompanying drawings.

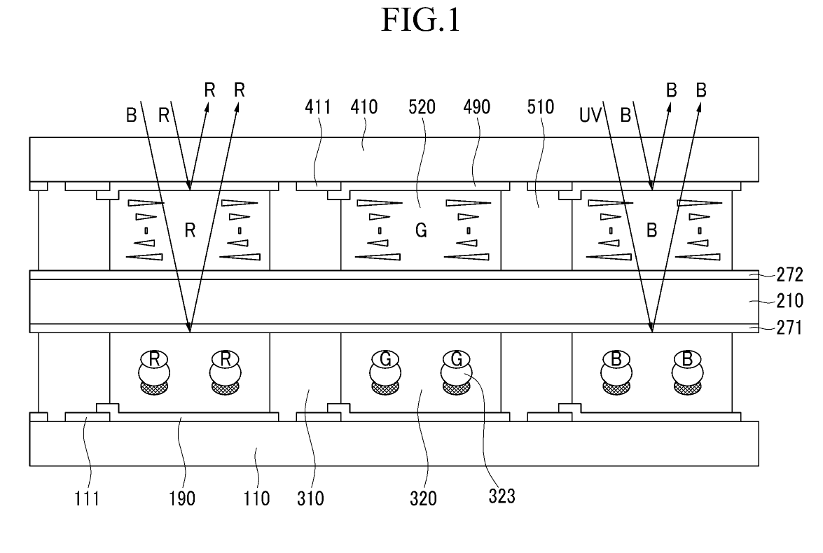

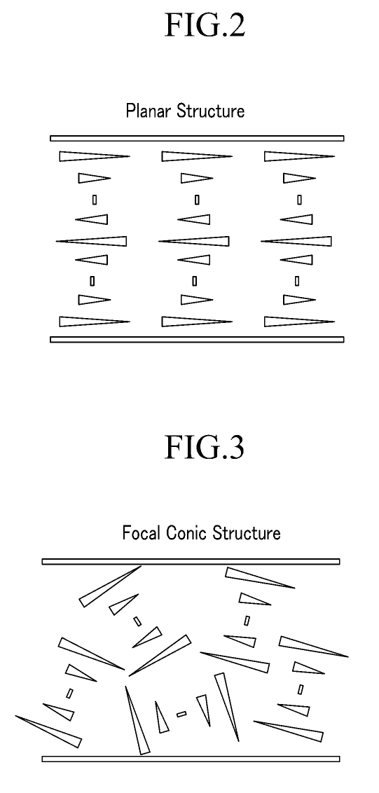

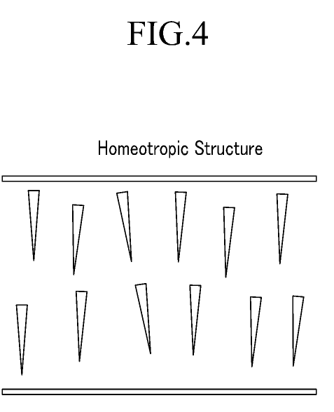

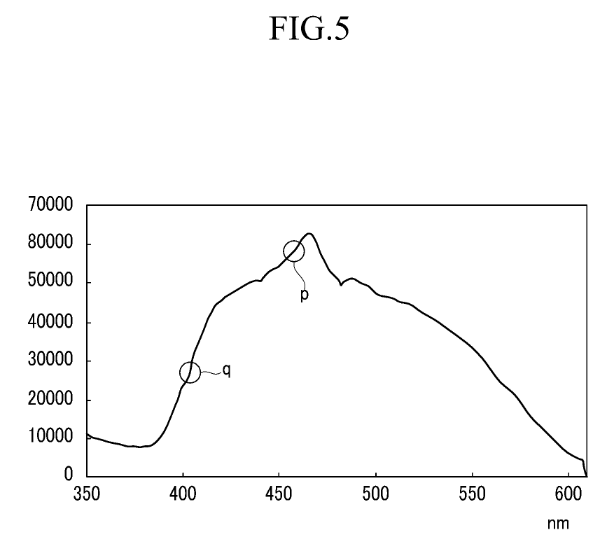

FIG. 1 is a cross-sectional view of an exemplary embodiment of a display device, according to the present invention, FIG. 2 is a schematic cross-sectional view illustrating a planar structure of a cholesteric liquid crystal, FIG. 3 is a schematic cross-sectional view of a focal conic structure of a cholesteric liquid crystal, and FIG. 4 is a schematic cross-sectional view of a homeotropic structure of a cholesteric liquid crystal.

An exemplary embodiment of a display device according to the present invention includes a cholesteric liquid crystal display (“LCD”) and an electrophoretic display. The cholesteric LCD and the electrophoretic display are aligned and combined for the pixel areas to correspond to each other.

Firstly, the cholesteric LCD will be described.

The cholesteric LCD includes an insulation substrate 410, a pixel electrode 490 formed under the insulation substrate 410 (with reference to the drawing), and a thin film transistor 411 switching voltages applied to the pixel electrode 490. Although not shown, exemplary embodiments of the insulation substrate 410 may include wiring such as a gate line supplying scanning signals to the thin film transistor, and a data line supplying data signals.

Also, the cholesteric LCD includes an insulation substrate 210 facing the insulation substrate 410 with a predetermined interval therebetween, and a common electrode 272 formed on the insulation substrate 210.

A region division member 510, which divides the two insulation substrates 410 and 210 into a plurality of regions, is formed between the two insulation substrate 410 and 210. Each region divided by the region division member 510 corresponded to a pixel electrode 490. That is, in the present exemplary embodiment, the region division members 510 enclose the circumference of the pixel electrodes 490.

Each region (hereinafter referred to as a “cholesteric liquid crystal region”) divided by the region division member 510 is filled with a cholesteric liquid crystal material 520. The cholesteric liquid crystal material 520 includes a chiral dopant, and the cholesteric liquid crystal region is divided into three regions including a red reflection region R, a green reflection region G, and a blue reflection region B according to the concentration of the chiral dopant. The cholesteric liquid crystal forms a spiral arrangement, and a helical pitch of the spiral arrangement of the cholesteric liquid crystal is changed according to different concentrations of the chiral dopant. The helical pitch is decreased according to an increase of the concentration of the chiral dopant.

The cholesteric liquid crystal layer forming the spiral arrangement has a selective reflection characteristic with respect to incident light. For example, a left hand circle cholesteric liquid crystal has a characteristic by which left-circle polarized light is transmitted and right-circle polarized light is reflected. Also, light of a specific wavelength is reflected according to the helical pitch of the cholesteric liquid crystal. Accordingly, the color of the light reflected in the cholesteric liquid crystal region may be varied by controlling the pitch of the spiral arrangement of the cholesteric liquid crystal, e.g., by controlling the concentration of the chiral dopant.

In an exemplary embodiment of the present invention, the cholesteric liquid crystal region is divided into the red reflection region R, the green reflection region G, and the blue reflection region B, and the helical pitch of the cholesteric liquid crystal is controlled for them to reflect the red light, the green light, and the blue light, respectively. In such an exemplary embodiment, when the average refractive index of the cholesteric liquid crystal material is referred to as n, the helical pitches of the cholesteric liquid crystal are referred to as Pr, Pg, and Pb in the red reflection region R, the green reflection region G, and the blue reflection region B, respectively, and the central wavelengths of the light reflected in the red reflection region R, the green reflection region G, and the blue reflection region B are referred to as λr, λg, and λb, respectively, wherein

λr=nPr, λg=nPg, and λb=nPb, and

the amount of the chiral dopant is controlled in each of the reflective regions for these equations to be satisfied. Accordingly, the concentration of the chiral dopant is highest in the blue reflection region having the shortest wavelength, is intermediate in the green reflection region, and is lowest in the red reflection region.

Exemplary embodiments include configurations wherein the plurality of regions divided by the region division members 510 may additionally have different color reflection regions as well as the red reflection region, the green reflection region, and the blue reflection region, and may be replaced with regions displaying different colors.

The cholesteric liquid crystal has three states that are formed of the different arrangements of the liquid crystal, as shown in FIG. 2 to FIG. 4. They are a planar state, a focal conical state and a homeotropic state. These states of three different arrangements may be changed by applying an electric field to the cholesteric liquid crystal, and the cholesteric liquid crystal may be controlled to be one of the three states or an intermediate state thereof by controlling the method of application of the electric field (continuous electric field application or intermittent electric field application) or the intensity of the electric field. That is, the voltage applied between the pixel electrode 490 and the common electrode 272 may be varied to control the states of the cholesteric liquid crystal.

The focal conic state and the planar state among the three arrangement states are stable such that the arrangement state is maintained even when the electric field is removed after completing the arrangement. Also, the cholesteric liquid crystal material 520 is almost transparent such that the light is not reflected but is transmitted in the focal conic state or the homeotropic state, the light of the special wavelength is reflected in the planar state. Accordingly, in one exemplary embodiment, the focal conic state or the homeotropic state may be used to realize black and the planar state may be used to realize white.

Next, the electrophoretic display will be described.

The electrophoretic display includes an insulation substrate 110, a pixel electrode 190 formed on the insulation substrate 110, and a thin film transistor 111 for switching the voltage applied to the pixel electrode 190. Although not shown, wiring, such as a gate line supplying a scanning signal to the thin film transistor and a data line supplying a data signal, may be formed on the insulation substrate 110.

Also, the electrophoretic display includes the insulation substrate 210 facing the insulation substrate 110 with a predetermined interval therebetween, and a common electrode 271 formed on the insulation substrate 210. In one exemplary embodiment the insulation substrate 210 is a single body. Alternative exemplary embodiments include configurations wherein the insulation substrate includes two separate insulation substrates (not shown) which are joined together. Alternative exemplary embodiments also include configurations wherein the location of the pixel electrode 490 and thin film transistor 411 and the common electrode 272 may be switched, e.g., as shown in FIG. 1, the pixel electrode 490 may be disposed below the common electrode 272. A similar alternative arrangement may be configured for the electrophoretic display.

In an exemplary embodiment of the present invention, the cholesteric LCD and the electrophoretic display share the insulation substrate 210 and the common electrodes 271 and 272 are formed on both surfaces of the insulation substrate 210, however the cholesteric LCD and the electrophoretic display may respectively include two insulation substrates. Also, the thin film transistor and the pixel electrode may be formed on at least one surface among the shared surfaces of the insulation substrate 210.

Region division members 310 divide the space between the insulation substrates 110 and 210 into a plurality of regions and are formed between the insulation substrates 110 and 210. Each region divided by the region division members 310 corresponds to a pixel electrode 190. That is, in one exemplary embodiment the region division members 310 are formed with a shape enclosing the edges of the pixel electrodes 190.

An electrophoretic material 320 is filled in each region (hereinafter referred to as “an electrophoretic region”) divided by the region division members 310. In one exemplary embodiment, the electrophoretic material 320 includes electrophoretic particles 323 disposed within a dispersion media. The electrophoretic particles 323 have a polarity such that they may be controlled by an applied electric field between the pixel electrodes 190 and the common electrode 271. In one exemplary embodiment, one surface of the electrophoretic particles 323 is covered by an emitting body and the other surface is covered by a light absorption body. In one exemplary embodiment, the emitting body may be a material that receives light of a predetermined wavelength and converts and emits light of a longer wavelength, exemplary embodiments of which include quantum dots. The quantum dots are a material having a particle size of a nanometer scale and may be made of a material having different wavelengths of emitted light according to the particle size, such as CdSe, CdTe, and ZnSe. The light absorption body is a material that does not reflect, but rather absorbs visible light and in one exemplary embodiment may be an organic material including a black color pigment, or a double-layered structure of chromium and chromium oxide. In the present exemplary embodiment, the emitting body includes a red emitting body R emitting red light, a green emitting body G emitting green light, and a blue emitting body B emitting blue light. The electrophoretic regions are divided into a red emitting region, a green emitting region, and a blue emitting region according to the type of emitting body of the electrophoretic particle. However, alternative exemplary embodiments include configurations wherein a portion of the red emitting body, the green emitting body, and the blue emitting body may not be used, and an emitting body of another color may be included. These emitting bodies generally emit light of a corresponding wavelength by using blue light or ultraviolet rays as an excitation source.

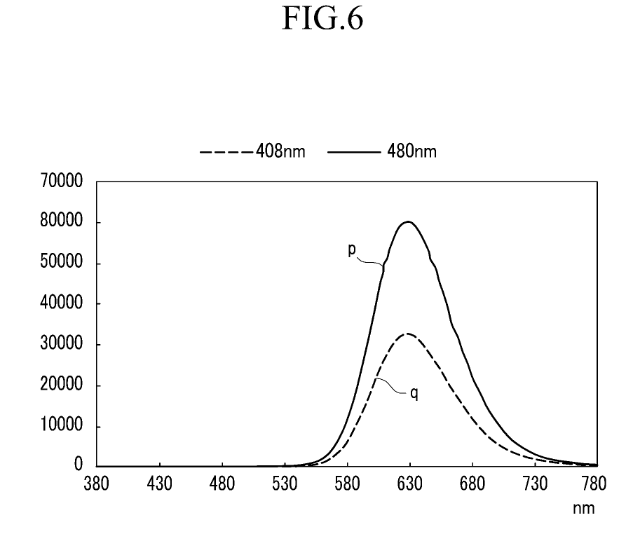

FIG. 5 is a graph of a wavelength distribution of an excitation source, and FIG. 6 is a wavelength distribution graph of red light obtained by applying the excitation source of FIG. 5 to the red emitting body of the red region of the electrophoretic display of FIG. 1. Referring to FIG. 5 and FIG. 6, it may be confirmed that the red emitting body emits red light using the light of the visible light region as the excitation source. Likewise, the green phosphor and the blue phosphor may respectively emit green light and blue light by using the natural light as the excitation source.

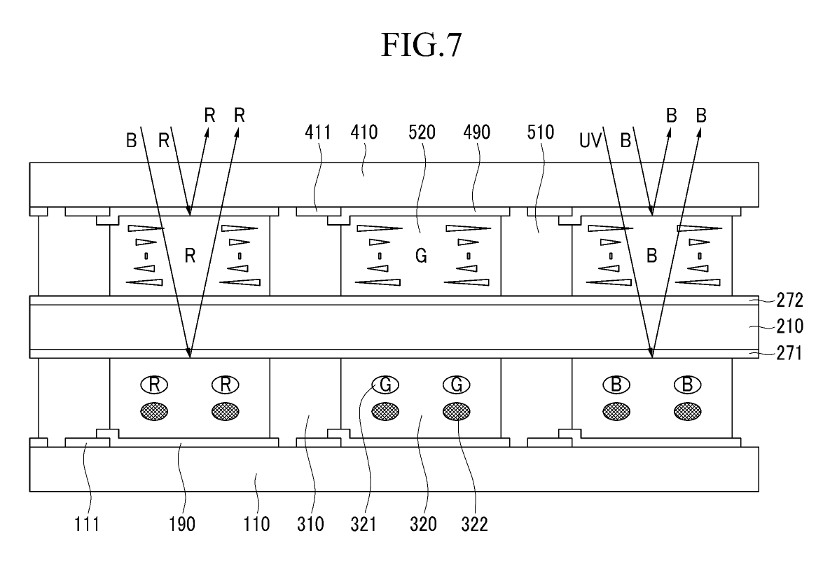

As shown in FIGS. 6 and 7, the wavelength distribution of the excitation source extends from at least 350 nm up to at least 600 nm. Two representative wavelengths have been selected to show their contribution to the output of the red emitting body of the electrophoretic display. The first wavelength p at 480 nm excites the red emitting body to emit at a peak intensity of about 80,000 and the second wavelength q nm excites the red emitting body to emit at a peak intensity of about 30,000 The resulting emission of the red emitting body is a combination of emissions due to all of the wavelengths of the excitation source.

The electrophoretic particles 323 may make the emitting body to be oriented toward the cholesteric LCD, and in contrast, for the light absorption body to be oriented toward the cholesteric LCD, by changing the polarity of the voltage applied between the pixel electrode 190 and the common electrode 271. If the emitting body is oriented toward to the cholesteric LCD, the externally incident light stimulates the emitting body such that one of the light of red, green, and blue is emitted in each emitting region (e.g., a white state), and if the light absorption body is oriented toward the cholesteric LCD, the light incident from the external is absorbed by the light absorption body such that light is not emitted from the electrophoretic display (e.g., a black state).

In the present exemplary embodiment, the cholesteric liquid crystal region of the cholesteric LCD and the electrophoretic region of the electrophoretic display are aligned for the color to be displayed. That is, the cholesteric liquid crystal region of the cholesteric LCD and the electrophoretic region of the electrophoretic display are aligned for the red reflection region R and the red emitting region to be vertically aligned with each other, the green reflection region G and the green emitting region to be vertically aligned with each other, and the blue reflection region B and the blue emitting region to be vertically aligned with each other.

In operation, if the red reflection region R of the cholesteric LCD becomes the planar state and the red emitting region of the electrophoretic display becomes the white state, the specific polarization component of the red among the external light is reflected in the red reflection region R of the cholesteric LCD, and the remaining light is incident to the red emitting region of the electrophoretic display. The blue light and ultraviolet components of the incident light stimulate the red emitting body to emit the red light. Accordingly, the cholesteric LCD adds the red light emitted by the electrophoretic display to the reflected red light such that the luminance of the display device is increased. The luminance increase is generated in the green and the blue pixels in the same way.

On the other hand, if the red reflection region R of the cholesteric LCD is formed as the focal conic state or the homeotropic state and the red emitting region of the electrophoretic display is formed as the black state, most of the external light passes through the cholesteric LCD as it is and arrives at the electrophoretic display, and the light that arrives at the electrophoretic display is absorbed by the light absorption body, thereby creating a dark display. Accordingly, a darker black is realized than if only the cholesteric LCD or the electrophoretic display were used individually. The black realization is generated in the green and blue pixels in the same way.

FIG. 7 is a cross-sectional view of another exemplary embodiment of a display device according to the present invention.

The exemplary embodiment of a display device according to FIG. 8 includes different electrophoretic particles 321 and 322 of the electrophoretic display compared with the exemplary embodiment of FIG. 1. That is, the electrophoretic particles 321 and 322 are divided into emitting particles 321 and light absorption particles 322, and the emitting particles 321 and the light absorption particles 322 are charged with opposite polarities. Accordingly, the emitting particles 321 move closer to the cholesteric LCD or the light absorption particles 322 move closer to the cholesteric LCD according to the polarity of the voltage applied between the pixel electrode 190 and the common electrode 271. The white and black display states may be realized through this operation.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A display device comprising:
a cholesteric liquid crystal display including a plurality of cholesteric liquid crystal regions, wherein each of the plurality of cholesteric liquid crystal regions respectively reflect light of predetermined colors, and the plurality of cholesteric liquid crystal regions are classified into two or more different types according to the predetermined color of the reflected light; and
an assistance display device including a plurality of emitting regions, wherein each of the plurality of emitting regions is disposed in alignment with one of the plurality of cholesteric liquid crystal regions, and each of the plurality of emitting regions respectively emits light of substantially the same color as the predetermined color of the light reflected by the cholesteric liquid crystal region with which it is aligned.

2. The display device of claim 1, wherein the cholesteric liquid crystal display comprises:
a first substrate;
a first pixel electrode disposed on the first substrate;
a first switching element disposed on the first substrate, and which switches a voltage applied to the first pixel electrode;
a second substrate facing the first substrate;
a first common electrode disposed on the second substrate;
a first region division member which divides a space between the first substrate and the second substrate into the plurality of cholesteric liquid crystal regions; and
a cholesteric liquid crystal material filled in the plurality of cholesteric liquid crystal regions.

3. The display device of claim 2, wherein the plurality of cholesteric liquid crystal regions are classified into a red reflection region, a green reflection region, and a blue reflection region according to the color of light reflected thereby, and the red reflection region, the green reflection region, and the blue reflection region are determined by an amount of chiral dopant disposed in the cholesteric liquid crystal material.

4. The display device of claim 3, wherein, when an average refractive index of the cholesteric liquid crystal material is n, the helical pitches of the cholesteric liquid crystal in the red reflection region, the green reflection region, and the blue reflection region are respectively Pr, Pg, and Pb, and the central wavelengths of the light reflected in the red reflection region, the light reflected in the green reflection region, and the light reflected in the blue reflection region are respectively λr, λg, and λb, and the following equalities:
λr=nPr, λg=nPg, and λb=nPb
are satisfied.

5. The display device of claim 4, wherein the assistance display device comprises:
a third substrate;
a second pixel electrode disposed on the third substrate;
a second switching element disposed on the third substrate, and which switches a voltage applied to the second pixel electrode;
a fourth substrate facing the second substrate;
a second common electrode disposed on the fourth substrate;
a second region division member which divides the space between the third substrate and the fourth substrate into the plurality of emitting regions; and
an electrophoretic material filled in the plurality of emitting regions, and including electrophoretic particles having an emitting portion and a dispersion media.

6. The display device of claim 5, wherein the plurality of emitting regions are classified into a red emitting region, a green emitting region, and a blue emitting region according to a color of the light which is emitted thereby, and the red emitting region, the green emitting region, and the blue emitting region are determined by an emitting material disposed in the emitting portion of the electrophoretic particles.

7. The display device of claim 6, wherein the electrophoretic particles further comprise a light absorption portion disposed on a side substantially opposite to a side on which the emitting portion is disposed.

8. The display device of claim 7, wherein the emitting portion of the electrophoretic particles comprises phosphor.

9. The display device of claim 7, wherein the emitting portion of the electrophoretic particles comprises quantum dots.

10. The display device of claim 7, wherein the second substrate is the same substrate as the fourth substrate, and a first common electrode and a second common electrode are respectively disposed on opposite surfaces of the same substrate.

11. The display device of claim 6, wherein the electrophoretic material comprises electrophoretic particles having a light absorption portion, and wherein the electrophoretic particles having the light absorption portion are separated from the electrophoretic particles having the emitting portion.

12. The display device of claim 1, wherein
the assistance display device comprises:
a third substrate;
a second pixel electrode disposed on the third substrate;
a second switching element disposed on the third substrate, and which switches a voltage applied to the second pixel electrode;
a fourth substrate facing the second substrate;
a second common electrode disposed on the fourth substrate;
a second region division member which divides the space between the third substrate and the fourth substrate into the plurality of emitting regions; and
an electrophoretic material filled in the plurality of emitting regions, and including electrophoretic particles having an emitting portion and a dispersion media.

13. The display device of claim 12, wherein the plurality of emitting regions are classified into a red emitting region, a green emitting region, and a blue emitting region according to the color of the light which is emitted thereby, and the red emitting region, the green emitting region, and the blue emitting region are determined by an emitting material disposed in the emitting portion of the electrophoretic particles.

14. The display device of claim 13, wherein the electrophoretic particles further comprise a light absorption portion disposed substantially opposite to the emitting portion.

15. The display device of claim 14, wherein the emitting portion of the electrophoretic particle comprises phosphor.

16. The display device of claim 14, wherein the emitting portion of the electrophoretic particle comprises quantum dots.

17. The display device of claim 14, wherein when cholesteric liquid crystal disposed in the cholesteric liquid crystal region is in a focal conic state or a homeotropic state, the light absorption portion of the electrophoretic particles is oriented toward the cholesteric liquid crystal display.

18. The display device of claim 17, wherein when the cholesteric liquid crystal of the cholesteric liquid crystal region is in a planar state, the emitting portion of the electrophoretic particles is oriented toward the cholesteric liquid crystal display.

19. The display device of claim 13, wherein the electrophoretic material comprises electrophoretic particles having a light absorption portion, and wherein the electrophoretic particles having a light absorption portion are separated from the electrophoretic particles having the emitting portion.

20. The display device of claim 19, wherein when the cholesteric liquid crystal of the cholesteric liquid crystal region is in a focal conic state or a homeotropic state, the electrophoretic particles having the light absorption portion are disposed closer to the cholesteric liquid crystal display than the electrophoretic particles having the emitting portion.

21. The display device of claim 20, wherein when the cholesteric liquid crystal of the cholesteric liquid crystal region is in a planar state, the electrophoretic particles having the emitting portion are disposed closer to the cholesteric liquid crystal display than the electrophoretic particles having the light absorption portion.
